(19) United States
(12) Patent Application Publication
(10) Pub. No.: US 2006/0232707 A1
(43) Pub. Date: Oct. 19, 2006

(54) Broadcast receiver and broadcast receiving method

(75) Inventor: Takahiro Kimura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/403,839

(22) Filed: Apr. 14, 2006

(30) Foreign Application Priority Data
Apr. 14, 2005 (JP) 2005-117285

(51) Int. Cl. H04N 5/44

(52) U.S. Cl. 348/553

(57) ABSTRACT

Forms of operational situation display panels can be switched to desired forms at any time without being affected by an operation state of a broadcast receiver. The broadcast receiver comprises a control section for controlling operations, and on the basis of control by the control section, receives a broadcast signal by a receiving section, demodulates to process the received signal to convert it into a display signal and stores the display signal on a recording medium in response to an operation input. A storage section stores a plurality of types of the operational situation display panels in advance. An operational situation display panel control section of the broadcast receiver has a function of selecting any one of forms of the operational situation display panels in response to a switching operation at arbitrary time to output it as video to a screen.

### CROSS-REFERENCE TO RELATED APPLICATIONS

This application is based upon and claims the benefit of priority from Japanese Patent Application No. 2005-117285, filed Apr. 14, 2005, the entire contents of which are incorporated herein by reference.

### BACKGROUND

1. Field

Embodiments of the present invention relate to a broadcast receiver and a broadcast receiving method. More specifically, one embodiment of the invention is an improved display method of panels showing replay operational situations on a screen.

2. Description of the Related Art

In recent years, an information recording medium such as a hard disk and an optical disk as a recording medium has been increased in its recording capacity. Therefore, a method and an apparatus for automatically video recording a desired program in an information recording medium by connecting a recording/replaying apparatus using the information recording medium to a television (TV) receiver, etc., have become used.

Program video recording reservation information is prepared by using electronic program guide (EPG) information for achieving an automatic video recording function and an automatic video recording/replaying apparatus. Then, the video recorded program can be arbitrarily displayed.

Here, operational situation display panels become available on the screen so as to allow a user to recognize operational situations. The situation display panels have a variety of types and the types are determined by the manufacture or by the model. As to the situation display panels, for example, reservation time display is designed for making a reservation by means of a timer. In such a technique, in a patent document of a Japanese application, for example, Jpn. Pat. Appln. KOKAI Publication No. 02-251785 has been disclosed. This reservation time display can display time display panels in a plurality of types and select any type to be used. This reservation time display can utilize a 0-12 o'clock based display type or a 0-24 o'clock based display type.

Display forms of conventional operational situation display panels are frequently determined by the model and a user cannot select the display forms freely. As to the situation display panel, there is one capable of selecting a display form of reservation time; however it is poor in diversity and it can set the display form only at the time of making a reservation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view shown to explain an outline of a digital TV broadcast receiving system with the present invention applied thereto;

FIG. 2 is an exemplary view showing an external appearance of a digital TV broadcast receiver in FIG. 1;

FIG. 3 is an exemplary view shown to explain the inside of the TV broadcast receiver in FIG. 1 more specifically;

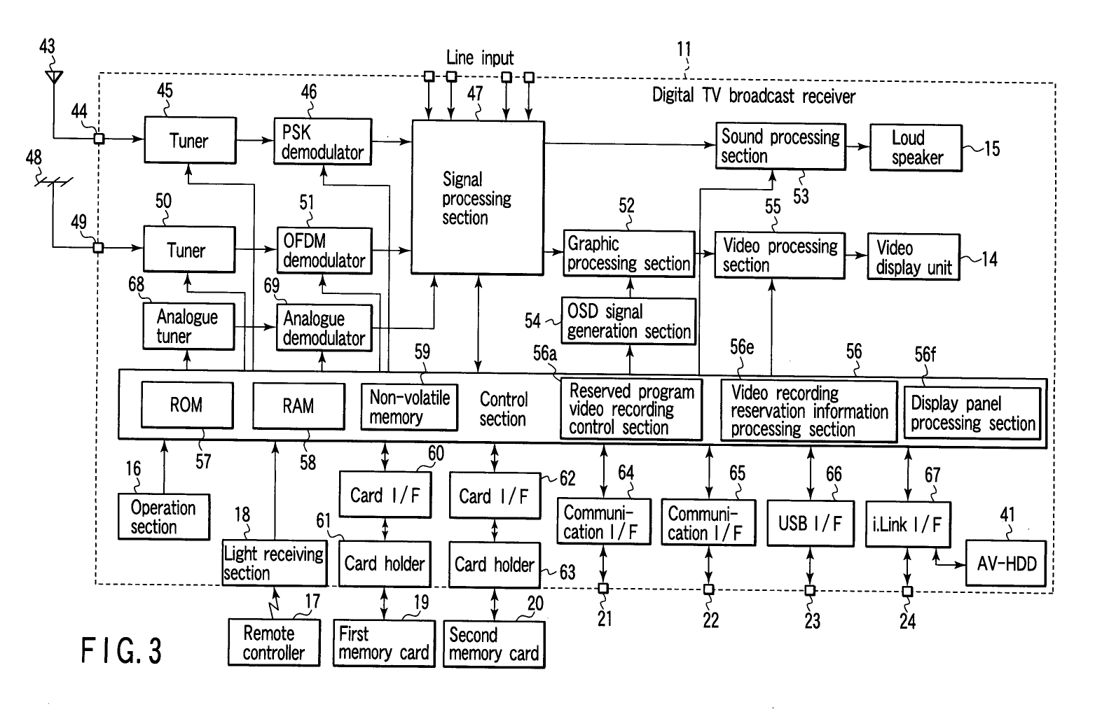

FIG. 4 is an exemplary view shown to explain an outline of a remote controller for use in the TV broadcast receiver of the present invention;

FIG. 5 is a flowchart shown to explain operations of the TV broadcast receiver in FIG. 1 in recording a program on the basis of EPG information;

FIG. 6 is an exemplary view showing an example when program information is displayed on a video display unit in the TV broadcast receiver in FIG. 1;

FIG. 7 is a flowchart for explaining operations of the digital TV broadcast receiver in the embodiment to replay a program from digital recording equipment;

FIG. 8 is a view for explaining an example of a navigation menu displayed in the replay operations of the TV broadcast receiver in the embodiment;

FIG. 9 is a view for explaining a situation in which an item of a recording program from the navigation menu in the embodiment;

FIG. 10 is a view for explaining an example of a list-display screen of a program recorded lately obtained from the navigation menu in the embodiment;

FIG. 11 is a view shown to explain an example of a screen when an operational situation display panel to be a feature of the embodiment of the present invention is displayed;

FIG. 12 is an exemplary view showing examples of types of the operational situation display panels;

FIG. 13 is an exemplary view showing a specific configuration of a control section to switch the situation display panels; and

FIG. 14 is a flowchart shown to explain switching operations of the situation display panels.

### DETAILED DESCRIPTION

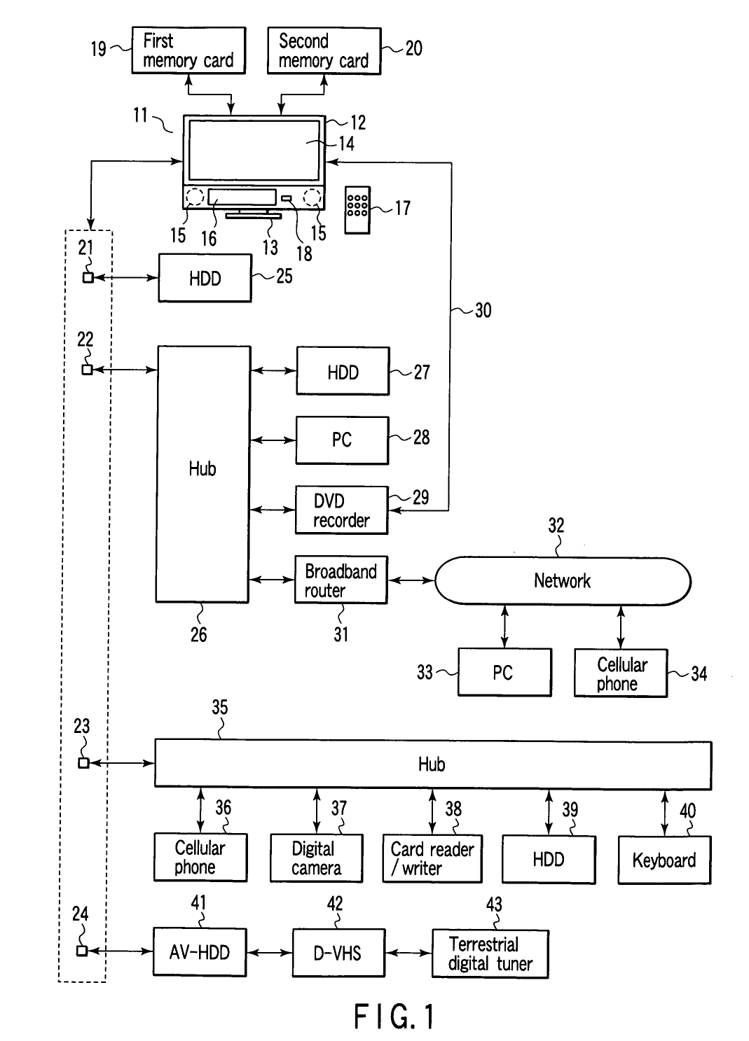

Various embodiments according to the invention will be described hereinafter with reference to the accompanying drawings. FIG. 1 shows the configuration of a flat-panel video display apparatus to which the present invention is applied.

One embodiment of the invention is to provide a broadcast receiver and a broadcast receiving method capable of switching a form of an operational situation display panel to a desired form thereof at any time without being affected by an operational situation of the receiver.

The broadcast receiver according to the embodiment comprises: a storage section which stores a plurality of operational situation display panels; and an operational situation display panel control section which selects any one of the operational situation display panels in response to a selective operation at any time to output it as video to a screen. The situation display panels include at least a type to perform counter display of a replay situation and a type to perform time display thereof. Furthermore, the receiver may comprise computing means for displaying a replay position by counter value or time to display the replay positions on the situation display panels.

FIG. 1 schematically shows an external appearance of a digital TV broadcast receiver 11 described in this embodiment and an example of a network system configured around the broadcast receiver 11 as a center.

The broadcast receiver 11 is composed of a thin-type cabinet 12 and a support stand 13 supporting the cabinet 12 by standing it. The cabinet 12 houses a video display unit 14 of a flat-panel type composed of a liquid crystal display panel or the like, a loud speaker 15, an operation section 16, and a light receiving section 18 for receiving operation information transmitted from a remote controller 17.

And, a first memory card 19 such as a secure digital (SD) memory card, a multimedia card (MMC) and a memory stick are detachable to the broadcast receiver 11 and the first memory card 19 records and replays information on a program, a photograph, etc.

Moreover, a second memory card (IC card) 20 with contract information, etc., recorded thereon is detachable to the broadcast receiver 11 and the second memory card 20 records and replays information.

Further, the broadcast receiver 11 has a first local area network (LAN) terminal 21, a second LAN terminal 22, a universal serial bus (USB) terminal 23 and an i.Link (registered trademark) terminal 24.

Among these terminals 21-24, the first LAN terminal 21 is used as a dedicated LAN-compliant HDD port. The first LAN terminal 21 is used to perform recording/replaying of information to/from a LAN-compliant HDD 25 through Ethernet (registered trademark).

As described above, by providing the first LAN terminal 21 as the dedicated LAN-compliant HDD port therewith, the broadcast receiver 11 can stably record information on a program provided through a high-vision image quality to the LAN-compliant HDD 25 without being affected by other network environments, network use situations and the like.

The second LAN terminal 22 is used as a generic LAN-compliant port using Ethernet (registered trademark). The second LAN terminal 22 connects a LAN-compliant HDD port 27, personal computer (PC) 28, a digital versatile disk (DVD) 29 with an HDD incorporated therein or the like through, for example, a hub 26 and can transmit/receive information to/from above-mentioned equipment.

Since digital information communicated through the second LAN terminal 22 is control-based information, the DVD recorder 29 needs to be provided with a dedicated analogue transmission path 30 to transfer analogue video and sound information to and from the broadcast receiver 11.

Furthermore, the second LAN terminal 22 is connected to a network 32 such as the Internet through a broadband router 31 which is connected to a hub 26 and used to transfer information to and from a PC 33, a cellular phone 34, etc., through the network 32.

The USB terminal 23 is used as a generic USB-compliant port, connected to, for example, a cellular phone 36, a digital camera 37, a card reader/writer 38 for a memory card, an HDD 39, a keyboard 40, etc., through a hub 35 or the like and used to transfer information to and from this equipment.

The i.Link (registered trademark) terminal 24 connects, for example, an AV-HDD 41, a digital (D)-video home system (VHS) 42 and the like in series with one another and is used to transfer information to and from this equipment.

Here, the AV-HDD 41 connected to the i.Link (registered trademark) terminal 24 is shown outside the receiver in FIG. 1; however, it is incorporated in the support stand 13 as a practical matter. That is, the AV-HDD 41 is integrated with the broadcast receiver 11.

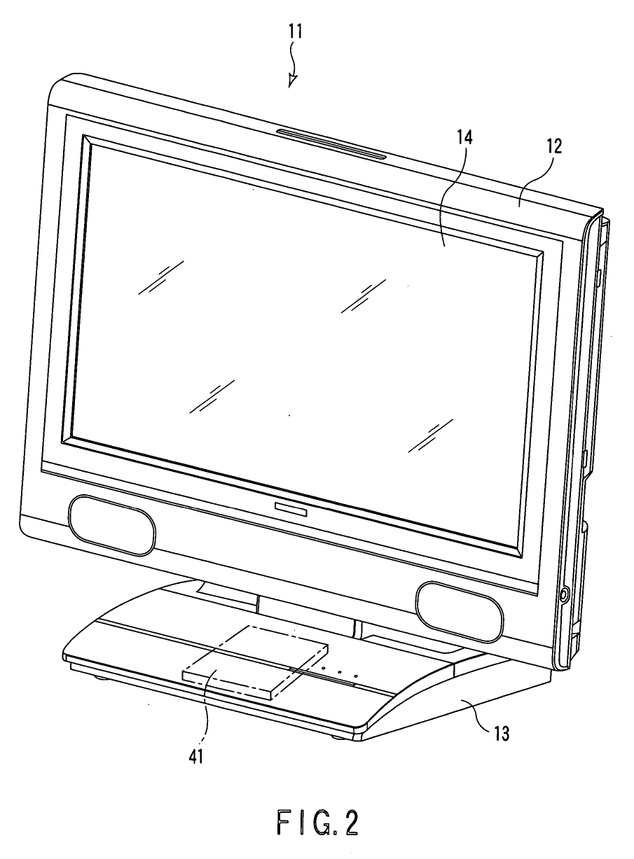

FIG. 2 shows the outline of the foregoing broadcast receiver 11. The AV-HDD 41 is incorporated in the support stand 13.

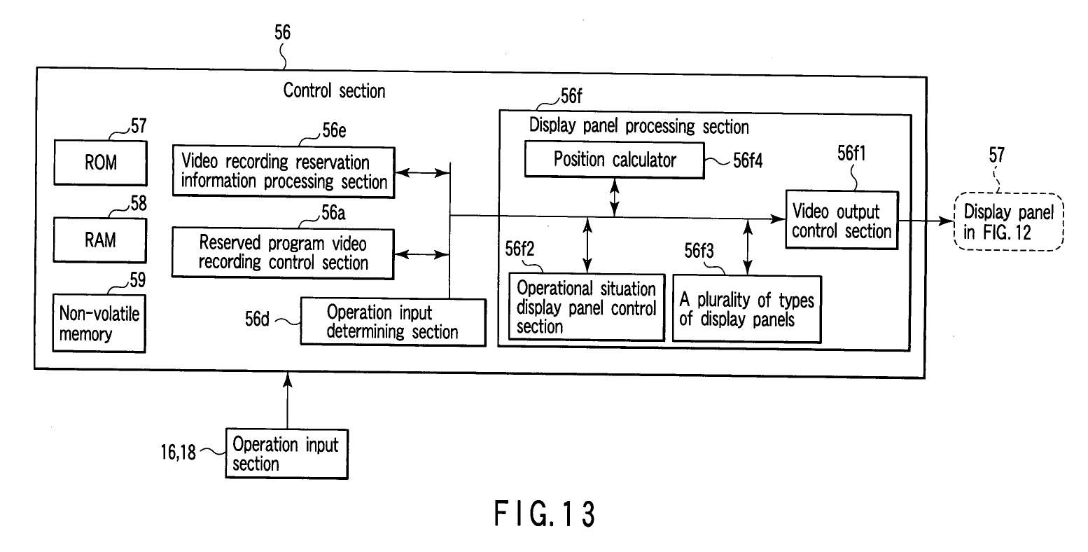

FIG. 13 shows a principle signal processing series of the above-mentioned broadcast receiver 11. That is, a satellite digital TV broadcast signal received by an antenna 43 for receiving a BS/CS digital broadcast is supplied to a tuner 45 for satellite digital broadcast through an input terminal 44, then a broadcast signal in a desired channel is tuned.

The broadcast signal tuned by the tuner 45 is supplied to a phase shift keying (PSK) demodulator 46 to be output to a signal processing section 47 after being decoding to a digital video signal and a sound signal.

The broadcast receiver 11 also has an analogue tuner 68 for receiving a terrestrial analogue signal. An analogue demodulator 69 demodulates the signal received by the analogue tuner 68 to output it to the signal processing section 47.

The terrestrial digital TV broadcast signal received through an antenna 48 for receiving terrestrial digital broadcast is supplied to a tuner 50 for terrestrial digital broadcast through an input terminal 49 and a broadcast signal in a desired channel is selected.

An orthogonal frequency division multiplexing (OFDM) demodulator 51 receives the broadcast signal tuned by the tuner 50 to demodulate it into a digital video signal and sound signal and outputs them to the signal processing section 47.

At this time, the signal processing section 47 selectively performs prescribed digital signal processing on the digital video signal and sound signal supplied from the PSK demodulator 46, the digital video signal and sound signal supplied from the OFDM demodulator 51, the video signal and the sound signal supplied from the analogue demodulator 69 and a video signal and a sound signal from a line input terminal and outputs the processed signals to a graphic processing section 52 and a sound processing section 53.

Among the above-mentioned equipment, the graphic processing section 52 has a function of superimposing an on screen display (OSD) signal generated from an OSD signal generation section 54 onto the digital video signal supplied from the signal processing section 47 to output it. The graphic processing section 52 can selectively output an output video signal from the signal processing section 47 and an output OSD signal output from the OSD signal generation section 54 and output both outputs by combing each output so as to respectively structure each half of a screen.

The digital video signal output from the graphic processing section 52 is supplied to a video processing section 55. This video processing section 55 converts the input digital video signal into an analogue video signal in a format possible to be displayed on the video display unit 14 and output it to the video display unit 14 to perform video display.

The sound processing section 53 converts the input digital sound signal into an analogue sound signal in a format possible to be replayed by the loud speaker 15 to output it to the loud speaker 15.

Here, the whole operation, including the foregoing various receiving operations of the broadcast receiver 11, is integrally controlled by a control section 56.

The control section 56 incorporates a central processing unit (CPU) and the like. When receiving operation information from the operation section 16, or when receiving operation information transmitted from the remote controller 17 through the light receiving section 18, the control section 56 respectively controls each section 16 and 18 so as to reflect operation contents to the broadcast receiver 11.

In this case, the control section 56 mainly utilizes a read only memory (ROM) 57 with the control program executed by the CPU stored thereon, a random access memory (RAM) 58 for providing a working area to the CPU and a non-volatile memory 59 with a variety of pieces of setting information and control information or the like stored thereon.

The control section 56 is connected to a card holder 61 on which the first memory card 19 can be mounted through a card interface (I/F) 60. The control section, thereby, can transfer information to and from the first memory card 19 mounted on the card holder 61 through the card I/F 60.

The control section 56 is connected to a card holder 63 on which the second memory card 20 can be mounted through a card I/F 62. The control section, thereby, can transfer information to and from the second memory card 20 mounted on the card holder 63 through the card I/F 62.

The control section 56 is connected to the first LAN terminal 21 through a communication I/F 64. Thereby, the control section 56 can transfer information to and from the LAN-compliant HDD 25 connected to the first LAN terminal 21 through the communication I/F 64. In this case, the control section 56 has a dynamic host configuration protocol (DHCP) server function and assigns an Internet protocol (IP) address to the LAN-compliant HDD 25 connected to the first LAN terminal 21 to control it.

The control section 56 is connected to the second LAN terminal 22 through a communication I/F 65. Thereby, the control section 56 can transfer information to and from each equipment (refer to FIG. 1) connected to the second LAN terminal 22 through the communication I/F 65.

The control section 56 is connected to the USB terminal 23 through a USB I/F 66. The control section 56, thereby, can transfer information to and from each equipment (refer to FIG. 1) connected to the USB terminal 23 through the USB I/F 66.

The control section 56 is connected to the i.Link (registered trademark) terminal 24 through an i.Link (registered trademark) I/F 67. Thereby, the control section 56 can transfer information to and from each equipment (refer to FIG. 1) connected to the i.Link (registered trademark) terminal 24 through the i.Link (registered trademark) I/F 67.

The control section 56 has a reserved program video recording control section 56a, a video recording reservation information processing section 56e and a display panel processing section 56f. We will describe the display panel processing section 56f in detail later, and it includes a video output control section, a display panel selection section and the like. These sections will be described in detail further later.

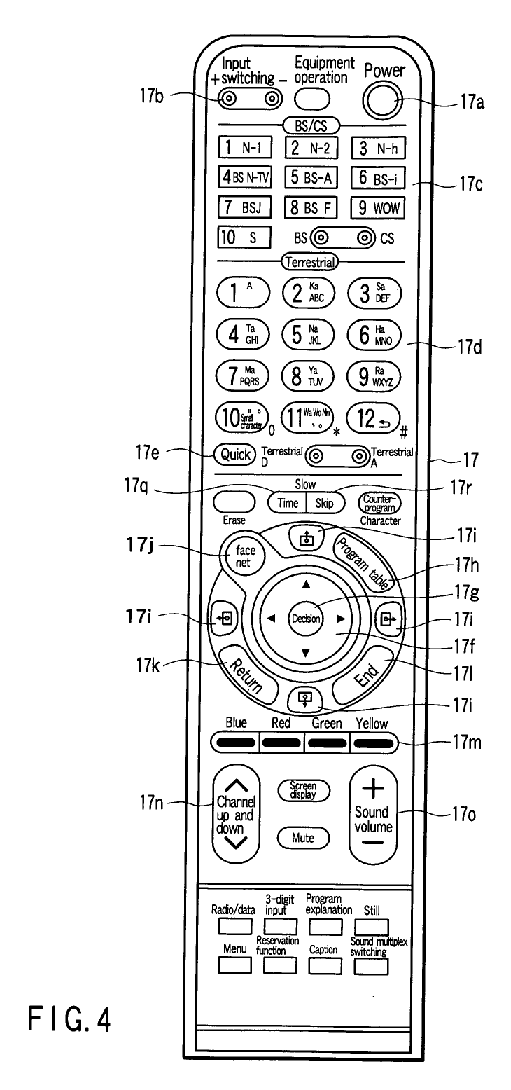

FIG. 4 shows the external appearance of the remote controller 17. The remote controller 17 includes mainly a power key 17a, an input switching key 17b, a direct selection key 17c for satellite digital broadcast channels, a direct selection key 17d for terrestrial broadcast channels, a quick key 17e, a cursor key 17f, a decision key 17g, a program table key 17h, a page switching key 17i, a face net (navigation) key 17j, a return key 17k, an end key 171, blue, red, green and yellow keys 17m, channel up and down key 17n, a sound volume control key 17o, etc. Furthermore, the remote controller 17 has a slightly time key 17q and a slightly skip key 17r.

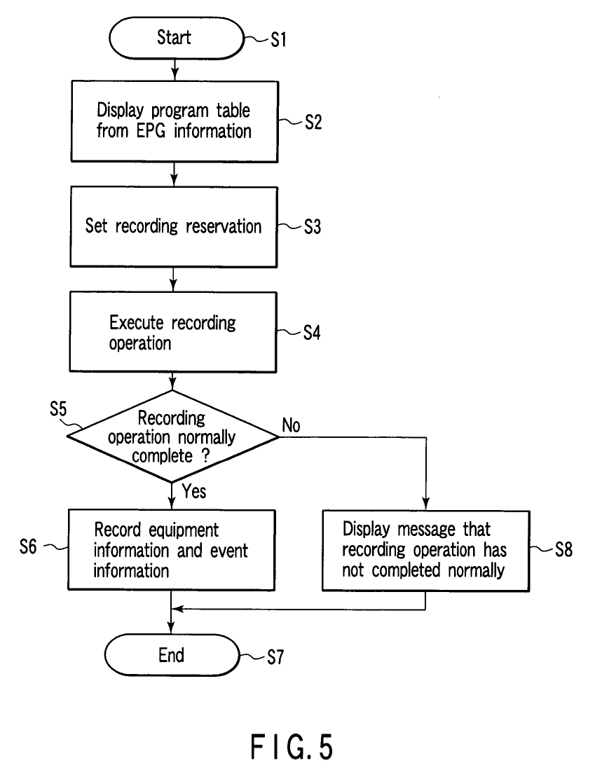

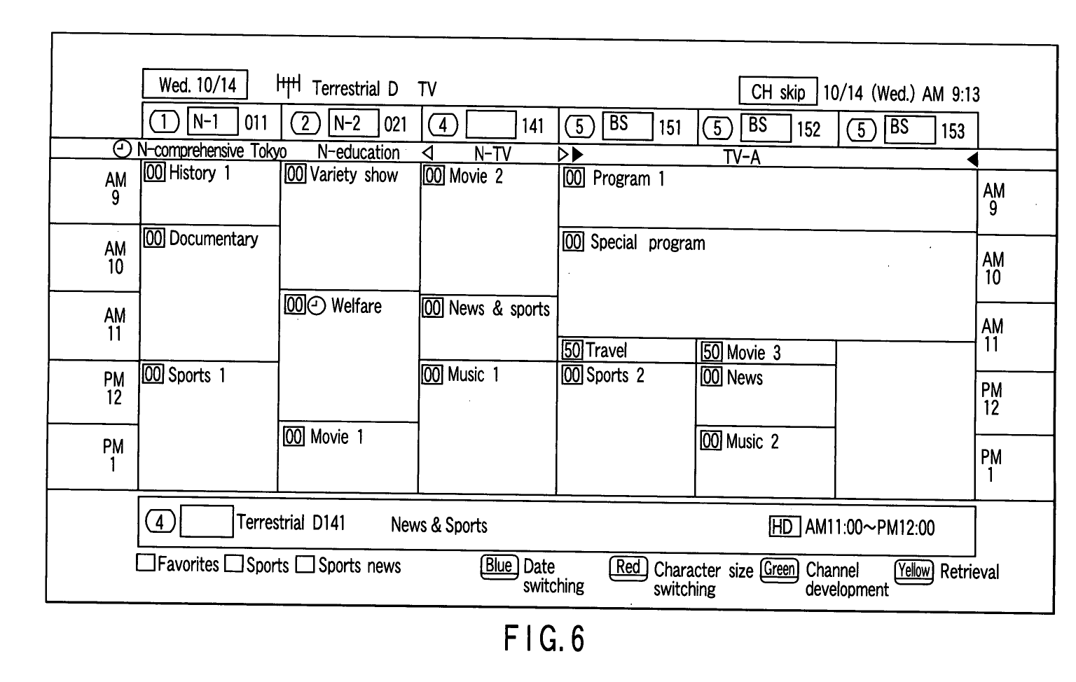

FIG. 5 shows a flowchart explaining operations of the broadcast receiver 11 to record a program to the digital recording equipment among each of the equipment connected to the terminals 21-24, respectively. That is, in step S1, when processing is started by the request of recording of a program, the control section 56, in step S2, displays a program table shown in FIG. 6 onto the video display unit 14 on the basis of the EPG information acquired from the broadcast signal.

In step S3, a user makes a video recording reservation of a desired program, based on the displayed program table. This video recording reservation selects a program to be recorded from the program table and also selectively sets the digital recording equipment by which the program is recorded.

Then, in step S4, when it has reached the setting time set through the video recording reservation, the control section 56 executes recording operations so as to record the reserved program onto the reserved digital recording equipment.

After this, in step S5, the control section 56 determines whether or not the program recording operations have normally completed, and if it is determined that the recording operations have normally completed (YES), the control section 56, in step S6, records equipment information (equipment ID, equipment name, shared folder name, etc.) to specify the digital recording equipment which has performed recording and event information (event ID, channel number, title, content explanation, category, recording range, image quality mode, etc.) in relation to the recorded program onto the non-volatile memory 59. And in step S7, the control section 56 ends the processing.

In step S5, if it is determined that the operations have not completed normally (NO), the control section 56, in step S8, displays a massage of the fact that the recording operations have not completely normally on the video display unit 14. And in step S7, the control section 56 ends the processing.

In accordance with the above-mentioned recording operations, the user can arbitrary select the plurality sets of digital recording equipment connected to each terminal 21-24 of the broadcast receiver 11, respectively and record the programs, respectively.

As described above, the broadcast receiver 11 video-records the desired programs to the desired digital recording equipment. Accordingly, when replaying the video-recorded contents, the broadcast receiver 11 displays a video recording list. When the user puts the cursor key 17f at a position of a name of a desired program in the video recording list to operate the decision button 17g, the selected program is replayed. The broadcast receiver 11 has a plurality of methods for displaying the video recording list. At first, the receiver 1 utilizes a method for displaying a plurality of equipment lists to select desired equipment and then requests a video recording list. Moreover, the broadcast receiver 11 utilizes another method for displaying the video recording list of the program which has been video-recorded recently without having to display the equipment lists. Since navigation screens are displayed in either method, the user can replay the desired programs by selecting items in accordance with the navigation. For example, when the user depresses the face net key 17j, the video recording list of the 36 pieces of programs which have been video-recorded recently is displayed on the screen.

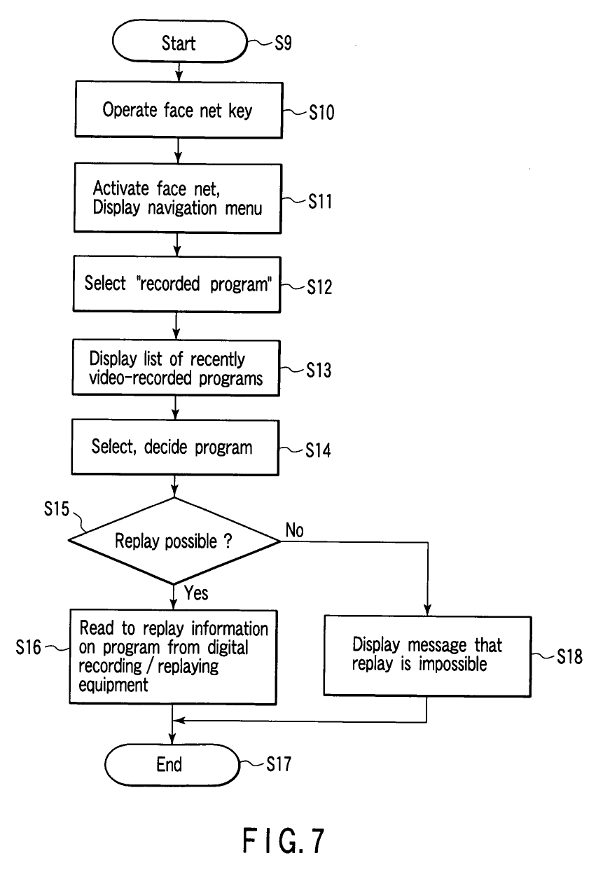

FIG. 7 shows a flowchart for explaining operations to quickly retrieve and replay the desired programs among a variety of programs recorded in a plurality of sets of digital recording equipment. That is, in step S9, when processing is started, the user, in step S10, operates the face net key 17j of the remote controller 17.

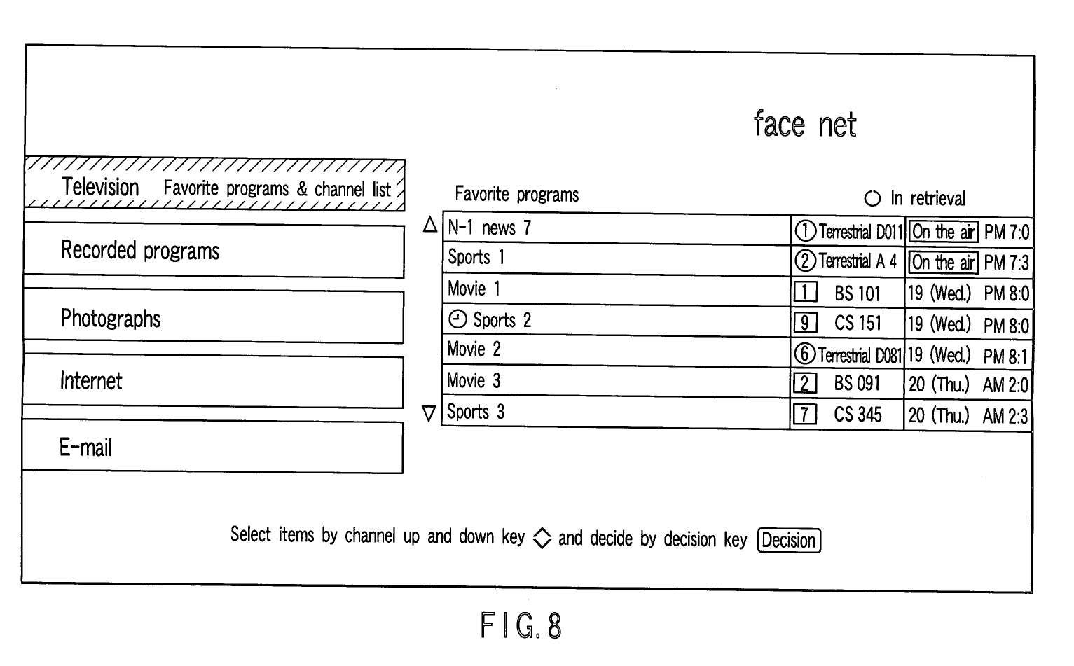

Then, in step S11, the control section 56 activates the face net (navigation) to display a navigation menu shown in FIG. 8 on the video display unit 14. In this navigation menu, five items of “TV”, “video recording program”, “photograph”, “Internet” and “e-mail” are provided so that they can be selected. The selected items are displayed in a different color from those of other items on the screen, and in FIG. 8, a state with the item of “TV” selected therein is indicated with hatching.

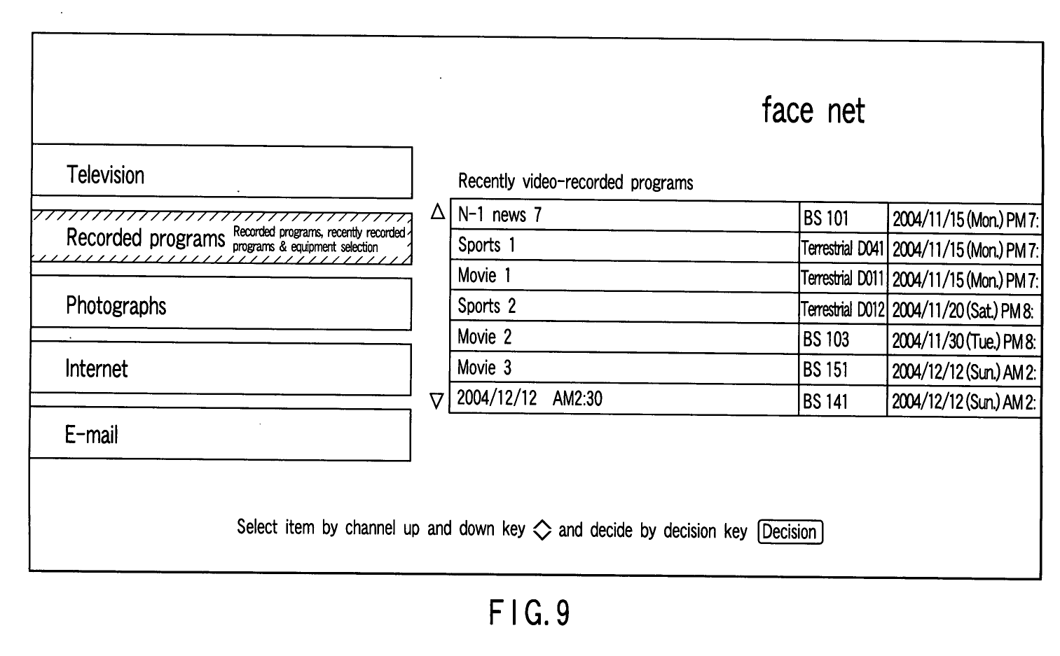

Here, in step S12, the user operates the cursor key 17f of the remote controller 17 to select the item of “video recorded program”. Then, the control section 56 takes on the state with the item of “video recorded program” selected therein, as indicated with hatching in FIG. 9.

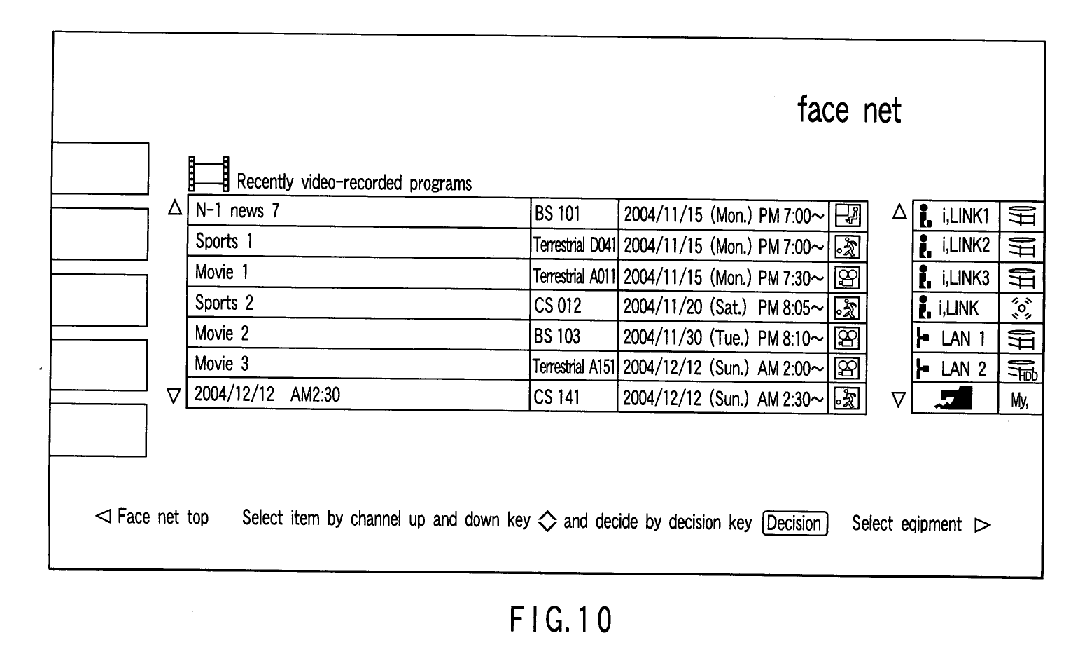

In this state, in step S13, when the user operates the decision key 17g of the remote controller 17, the control section 56, as shown in FIG. 10, displays the list of the programs which have been video-recorded recently on the video display unit 14. This list of the programs displays the titles, broadcast channels, recording dates, days of the week, hours, categories, etc., as information showing the recorded programs.

The list of the programs which have been video-recorded recently is created by referring to the equipment information specifying the digital recording equipment which has performed recording and the event information in relation to the recorded programs stored on the non-volatile memory 59 at the time of reserved recording of the programs as described for FIG. 5. The list of the programs which have been recently video-recorded can display a list of information showing 35 pieces of programs at a maximum as far as from the latest recorded program. In FIG. 10, seven programs are displayed in a list, and the user can see the list of 35 pieces of programs by operating the cursor key 17f to scroll the display. When operating the page switching key 17i of the remote controller 17, the user can skip, at one sitting, the seven programs displayed in the list.

Then, in step S14, when the user operates the cursor key 17f of the remote controller 17 to select and decide the desired program from the list of the programs which have been recently video-recorded by operating the decision key 17g, the control section 56 specifies, in step S15, the digital recording equipment with the selected and decided programs recorded therein from the information recorded on the non-volatile memory 59 and determines whether or not the programs can be replayed.

In this determination, for example, it is determined whether or not the broadcast receiver 11 is connected to the digital recording equipment with the program required to be replayed recorded therein, whether or not power is supplied to the digital recording equipment with the program required to be replayed recorded therein, whether or not the program required to be replayed is still recorded in the targeted digital recording equipment, and whether or not the program required to be replayed can be replayed by comprehensively comparing conditions in recording and in replay.

In step S15, if it is determined that the recorded program can be replayed (YES), the control section 56 controls the digital recording equipment so as to read out to replay, in step S16, the information on the program required to be replayed from the targeted digital recording equipment. And in step S17, the control section 56 ends the processing.

Further, in step S15, if it is determined that the recorded program cannot be replayed (NO), the control section 56 displays, in step S18, the massage of the fact that the program required to be replayed cannot be replayed onto the video display unit 14. And in step S17, the control section 56 ends the processing.

According to the replay operations described above, since the broadcast receiver 11 has a navigation function of list-displaying the 35 pieces of recorded programs at a maximum as far as from the latest recorded program regardless of the digital recording equipment which have recorded the programs, the user can easily manage the programs recorded in a plurality of sets of digital recording equipment. Therefore, the user can quickly retrieve to replay the desired program by selecting the desired program from the programs displayed in a list, by means of the cursor key 17f and deciding by means of the decision key 17g.

Regarding the increase in the number of the connected digital recording equipment and the recorded programs, it becomes impractical to display, in a list, all of the programs recorded in a plurality of sets of digital recording equipment. Like this embodiment, it becomes a practical setting which hardly causes substantial trouble for the user to display, in a list, 35 pieces of programs at a maximum as far as from the latest recorded-program.

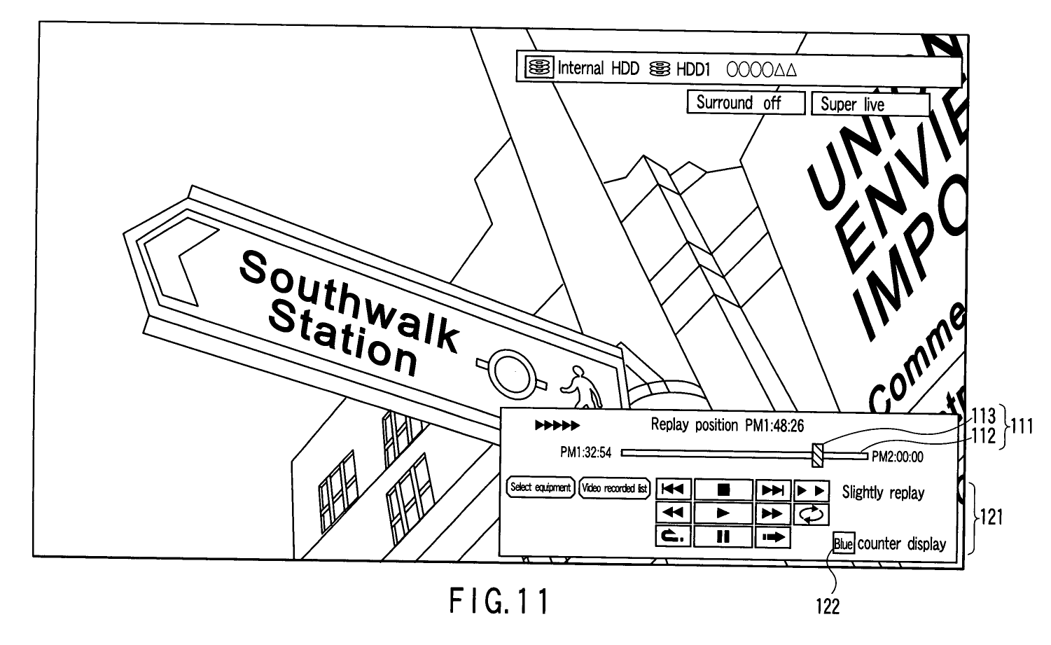

FIG. 11 shows an example of a screen to explain features of the broadcast receiver 11. FIG. 11 shows an aspect in which an operational situation display panel 111 is displayed during the replay of the desired program by the broadcast receiver 11 (refer to lower right on screen). In this screen, an aspect with the panel displaying time indicated therein is indicated. A video recording start time is indicated on the left side of on a bar 112 (PM 1:32:54, in shown example). Further, a video recording end time is indicated on the right side of the bar 112 (PM 2:00, in the shown example). A mark 113 is shown at the middle of the bar 112. This mark 113 indicates a replay position, and the time PM 1:48:26 is indicated as the replay position, on the bar 112. An operation panel 121 is also displayed at the lower part of the operational situation display panel 111. The operation panel 121 includes marks of a fast forward key, a temporally stop key, a repeat key, or the like. When operating the decision key 17g, the user can switch operation modes. On the operation panel 121, a selection button to shift to an equipment selection screen and a selection button to shift to a video recorded list screen are also displayed.

Furthermore, the user can switch the form of the operational display panel 111. A guide 122 to switch this form is guided, for example, to operate the blue color key 17m of the remote controller 17. This example shows the switching of the operational situation display panel 111 to counter display when the blue color key 17m is depressed.

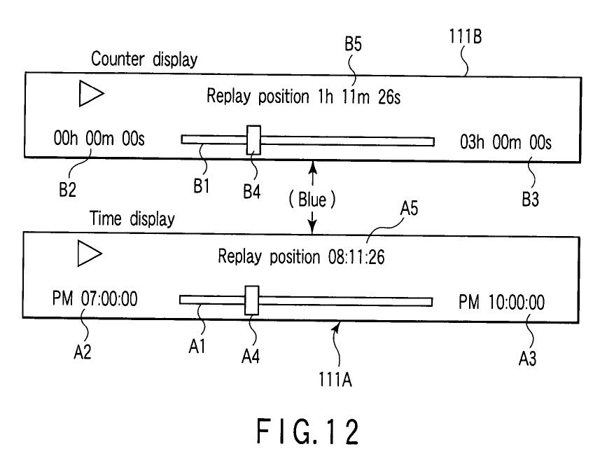

FIG. 12 shows an example of a display form on the operational situation display panel 111 which varies at the operation of the color keys 17m. A panel 111A of a lower stage in FIG. 12 is an example of the time display form as described above. That is, the panel 111A indicates a bar A1, a video recording start time A2, a video recording end time A3, a mark A4 indicating the replay position and a replay hour A5. A panel 111B in an upper stage in FIG. 12 shows an example of the counter display. This panel 111B indicates a bar B1, an initial value B2 of a counter, a final value B3 of the counter, a mark B4 indicating a current replay position and a count value B5 of the current replay position.

The user can freely switch the above-mentioned display forms by operating the blue color key 17m. In the screen in FIG. 11, it is designed for the operation panel 121 to disappear from the screen after the lapse in a prescribed time from the replay start time. It is designed to display the operation panel 121 again after that disappearance upon the user touching any key, for example, the return key 17k of the remote controller 17.

FIG. 13 shows a specific configuration of the control section 56 to switch the foregoing operational situation display panel 111. The control section 56 includes the video recording reservation information processing section 56e, the reserved program video recording control section 56a, and an operation input determining section 56d. The control section 56 also includes the display panel processing section 56f. The information processing section 56e is, as shown in FIG. 5 and FIG. 6, a control section for performing the recording reservation for the program. The video recording control section 56a is a control section for recording the reserved program to a prescribed recording medium when the broadcast time of the video recording reserved program comes.

The panel control section 56f includes a video output control section 56f1 to display the operational situation display panel on the screen as shown in FIG. 12. The panel processing section 56f also includes a storage section 56f3 with a plurality of types of display panels stored therein and an operational situation display panel control section 56f2 to determine an operation input and select switching of the operational situation display panels. Furthermore, the pane display processing section 56f also includes a replay position computing section 56f4. The computing section 56f4 has a function of obtaining data indicating the replay position shown in FIG. 12 by computing.

For example, in analogue broadcast, the control section 56 can obtain the information on the video recording start time and the video recording end time when program reservation information is set. Therefore, when the user wants to replay such a program, the user can acquire replay position information by computing through adding a counter value to the video recording start time. This is the reason to output the replay position information acquired like this in accordance with the display on the operational situation display panel.

The method for acquiring the replay position information as mentioned above can be applied to replay programs in digital broadcast. However, the broadcast receiver 11 may record the broadcast time information on the recording medium together with the recorded signal in video recording without having to acquire the broadcast time information by computing in replay. In this case, the broadcast receiver 11 does not need to perform computing in replay.

While two types, such as a time type and a counter type, of the operational situation display panel are described above, the user can display a desired type by storing a variety of operational situation display panels in the storage section 56f3. Of course, the present invention includes an option not to display any operational situation display panel, and in this case, the user may, for example, operate another specified color key.

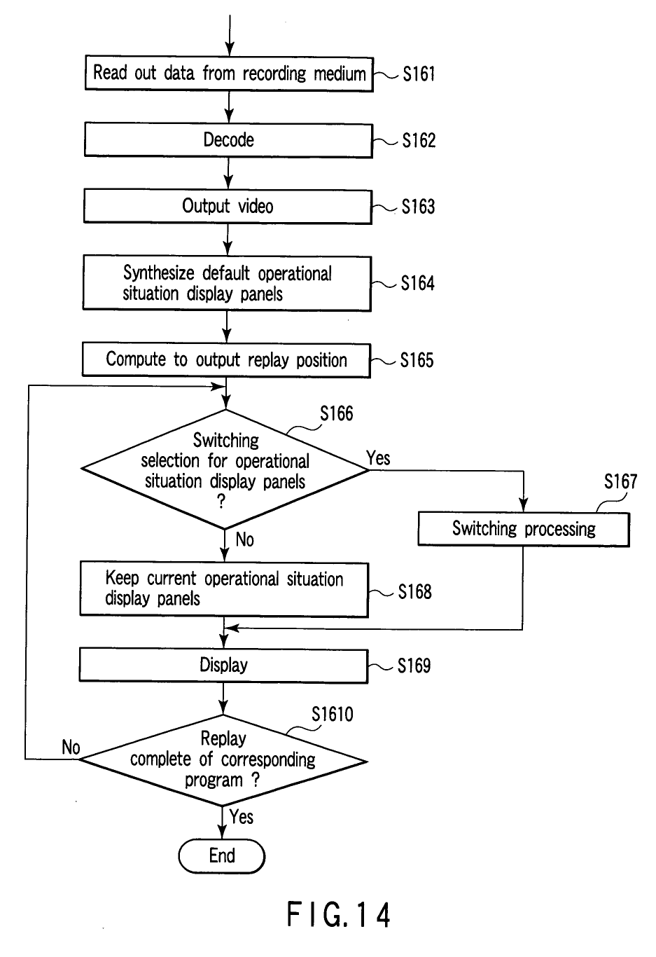

FIG. 14 is the flowchart showing operations to output the operational situation display panels during the replay of the video-recorded program. This flowchart further specifically shows the step S16 shown in FIG. 7. In steps S161, S162 and S163, the control section 56 performs the reading out of the data stored on the recording medium, the decoding processing of the data and the output of the decoded video signal. In step S164, the operational situation display panel is read out from the storage section 56f3 (at this time, the type which is set as default is read out, or the type which is used just before the setting is read out to be used). Next, in step S165, the replay position is computed and the display data is output.

In step S166, during the replay of the program or during the display of the operational situation display panels, it is determined whether or not an instruction to switch the operational situation display panels is issued. In step S167, if the instruction is issued, the switching is performed, and otherwise, in step S168, the currently displayed operational situation display panel is kept without any change. Then, in step S169, it is determined whether or not the replay of the reserved program has completed, if the replay has completed, the replay operation is terminated, and otherwise, the control section 56 is brought into a state without a break to check whether or not the instruction to switch the operational situation display panel has been issued.

In accordance with the above-mentioned embodiment, a viewer can watch a desired operational situation display panel on the screen and thus the usability for the user is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiver comprising:
a receiving section which receives a broadcast signal;
a signal processing section which demodulates to process a received signal and converts it into a display signal;
an output section which transmits the display signal to a recording medium in response to an operation input;
a control section which controls operations;
a storage section which stores a plurality of forms of operational situation display panels in advance; and
an operational situation display panel control section which selects any one form of the operational situation display panels in response to a switching operation at arbitrary time to output it as video to a screen.

2. The broadcast receiver according to claim 1, wherein
the operational situation display panels include at least a counter type for performing counter display of a replay state and a time type for performing time display of the replay state.

3. The broadcast receiver according to claim 1, wherein
the operational situation display panels include at least a counter type for performing counter display of a replay state and a time type for performing time display of the replay state, and
the operational situation display panel control section selects and outputs the operational situation display panels of the counter type and the time type cyclically in response to operation signals from a remote controller.

4. The broadcast receiver according to claim 1, in which
the operational situation display panels include at least a counter type for performing counter display of a replay state and a time type for performing time display of the replay state, and which further comprises
computing means for displaying replay positions by a counter value or time so as to display the replay positions on the operational situation display panels.

5. The broadcast receiver according to claim 1, further comprising:
means for outputting the operational situation display panels from the storage section during replay of a reserved and video-recorded program on the recording medium.

6. A broadcast receiving method for use in a broadcast receiver having:
a receiving section which receives a broadcast signal;
a signal processing section which demodulates to process the received signal and converts it into a display signal;
an output section which transmits the display signal to a recording medium in response to an operation input;
a control section which controls operations; and
a storage section which stores a plurality of forms of operational situation display panels in advance, comprising:
selecting any one form of the operational situation display panels in response to a switching operation at arbitrary time; and
outputting the selected operational situation display panel as video to a screen.

7. The broadcast receiving method according to claim 6, in which
the operational situation display panels include at least a counter type for performing counter display of a replay state and a time type for performing time display of the replay state, and which further comprises
selectively outputting at least the operational situation display panels of the counter type and the time type cyclically in response to operation signals from a remote controller.

8. The broadcast receiving method according to claim 6, in which
the operational situation display panels include at least a counter type for performing counter display of a replay state and a time type for performing time display of the replay state, and which further comprises
computing to display replay positions by a counter value or time so as to display the replay positions on the operational situation display panels.

9. The broadcast receiving method according to claim 6, further comprising
outputting the operational situation display panel during replay of a reserved and video recorded program on the recording medium.

10. The broadcast receiving method according to claim 6, in which
the operational situation display panels include at least a counter type for performing counter display of a replay state and a time type for performing time display of the replay state, and which further comprises
selectively outputting at least the operational situation display panels of the counter type and the time type cyclically in response to operation signals from a remote controller; and
erasing the displayed operational situation display panels when a prescribed time period has elapsed after the operational situation display panels are selectively displayed.

11. The broadcast receiving method according to claim 6, in which
the operational situation display panels include at least a counter type for performing counter display of a replay state and a time type for performing time display of the replay state, and which further comprises
displaying an operational situation display panel of a type displayed during the last turning on of a power supply of the broadcast receiver when the power supply is turned on.
